(19) United States
(12) Patent Application Publication
(10) Pub. No.: US 2005/0008845 A1
(43) Pub. Date: Jan. 13, 2005

(54) Electromagnetic-wave absorber

(76) Inventors: Hideyuki Hatanaka, Chiba-shi (JP); Masato Ohtsubo, Chiba (JP); Sadaaki Arikawa, Chiba (JP)

Correspondence Address: NIXON PEABODY, LLP, 401 9TH STREET, NW, SUITE 900, WASHINGTON, DC, 20004-2128, US

(21) Appl. No.: 10/488,781

(22) PCT Filed: Jan. 31, 2002
(86) PCT No.: PCT/JP02/00785

(51) Int. Cl. B32B 5/16; B32B 3/00; G21F 1/00

(52) U.S. Cl. 428/313.3; 428/156; 428/323; 428/317.9; 523/137

(57) ABSTRACT

An electromagnetic wave absorber characterized by comprising from 50 to 85% by weight of inorganic hollow material, from 0.01 to 35% by weight of conductive material, from 5 to 47.5% by weight of binder, and from 0.1 to 47.5% by weight of filler. It has a reduced angle dependence of electromagnetic wave absorption and has the property of absorbing electromagnetic waves over a wide range of angles. It further has satisfactory processability and workability.

### TECHNICAL FIELD

The present invention relates to an electromagnetic wave absorber which improves electromagnetic wave environments in the fields of building and engineering works and the like.

### BACKGROUND ART

Wireless communication devices represented by cell phones and PHS's have spread remarkably. In offices, stores, factories, warehouses, and the like, wireless communication devices for use in wireless data communication networks called wireless LAN's have been spreading rapidly. In the case where such wireless communication devices are used in a specific indoor space, e.g., an office, it is necessary to prevent the penetration of noise electromagnetic waves from the outside and prevent the leakage of indoor information to the outside. A technique for preventing such penetration and leakage is known which comprises applying an electromagnetic wave shielding material comprising a metal foil, mesh, conductive fibers, or the like. However, application of such an electromagnetic wave shielding material results in enhanced electromagnetic wave reflection in the room to pose the following problem. The electromagnetic wave sent from a wireless communication device is reflected by the inner walls, ceiling, and floor and by furniture or furnishings made of steel. As a result, reflected waves differing in phase reach a receiving terminal, or reflected waves reach in a multiple manner from the ceiling, walls, floor, etc. These electromagnetic waves cannot be recognized by the receiver side as normal signals, resulting in an abnormally prolonged communication time or communication impossibility. Troubles in electromagnetic wave communication due to buildings and the like, which are represented by television ghosts and troubles in charging systems in express highways, arise outdoors also.

A measure effective against those phenomena is to apply a member which inhibits electromagnetic wave reflection to an indoor interior material or exterior material. However, in the case where an inorganic adhesive is used as a binder as in the material disclosed in JP-A-2000-82893, this material has low mechanical strength and poor suitability for machining/cutting and is unsuitable for use as a building/construction material. On the other hand, materials of the type including a noncombustible layer united therewith so as to compensate for the deficiency in strength require a high processing cost and are costly when installed as an electromagnetic wave absorber for an electromagnetic dark room. Furthermore, the materials described in U.S. Pat. No. 6,214,454 and JP-A-2001-248260 have a high angle dependence of electromagnetic wave absorbing properties although they are inexpensive materials having electromagnetic wave absorbing properties. When electromagnetic waves strike on these materials at an increased angle of incidence because of the location of a radio base station, these electromagnetic wave absorbers show poor absorbing performance.

The carbon fibers in the material described in U.S. Pat. No. 6,214,454 are oriented in two-dimensional arrangement parallel to the thickness direction because the fibers orient in the direction of slurry flowing during molding. On the other hand, the composition system disclosed in JP-A-2001-248260 is produced through pressing in a dehydration step during wet molding mainly using rock wool, and this pressing orients the fibers in horizontal directions. The carbon fibers in this system also are oriented in two-dimensional arrangement parallel to the thickness direction.

Consequently, there has been the following problem. When the angle of incidence of electromagnetic waves is small, the electromagnetic waves strike perpendicularly to the carbon fibers and, hence, high absorbing performance is attained. However, when the angle of incidence is large, the amount of carbon fibers to which electromagnetic waves strike perpendicularly is small, resulting in reduced absorbing performance.

Furthermore, electromagnetic wave absorbers are required to have satisfactory processability to interior materials, exterior materials, or the like and workability.

### DISCLOSURE OF THE INVENTION

The invention has been achieved in view of those circumstances. An object of the invention is to provide an electromagnetic wave absorber which is reduced in the dependence of electromagnetic wave absorption on angles influenced by the arrangement of building/construction materials relative to wireless terminals and base stations, and which absorbs electromagnetic waves striking thereon at angles in a wide range so as to maximize the effective use of wireless communication characteristics and further has satisfactory processability and workability.

This object has been accomplished with an electromagnetic wave absorber characterized by comprising from 50 to 85% by weight inorganic hollow material, from 0.01 to 35% by weight conductive material, from 5 to 47.5% by weight binder, and from 0.1 to 47.5% by weight filler.

In the electromagnetic wave absorber of the invention, the presence of a given amount of the inorganic hollow material in the composition enables the conductive material to be disposed in three-dimensional arrangement or dispersed unevenly. As a result, the electromagnetic wave absorber obtained can have a significantly reduced angle dependence of electromagnetic wave absorption and be excellent in processability and workability.

### BRIEF DESCRIPTION OF THE DRAWING

FIG. 1 illustrates a preferred embodiment of the electromagnetic wave absorber of the invention.

### BEST MODE FOR CARRYING OUT THE INVENTION

[Inorganic Hollow Material]

The electromagnetic wave absorber of the invention contains an inorganic hollow material in an amount in the range of from 50 to 85% by weight.

The inorganic hollow material to be used may be either a natural or synthetic one as long as it is composed of hollow particles which are substantially inorganic.

This inorganic hollow material has an average particle diameter of preferably from 50 to 4,000 m, more preferably from 100 to 2,00 μm. When the average particle diameter thereof is smaller than 50 μm, there are cases where the conductive material is not disposed in sufficient three-dimensional arrangement. When the average particle diameter thereof is larger than 4,000 μm, there are cases where the proportion of the cavities in the hollow material is too large to obtain sufficient strength.

Preferred examples of the inorganic hollow material include perlite, Shirasu balloons, silica balloons, expanded glass beads, and alumina-silica balloons.

Inorganic hollow materials can be used alone or in combination of two or more thereof.

The content of the inorganic hollow material is from 50 to 85% by weight. In case where the content thereof is less than 50% by weight, the proportion of fibers and powder particles is necessarily high and the conductive material undesirably is oriented in two-dimensional arrangement or dispersed evenly. Furthermore, densification occurs undesirably, leading to a decrease in sound absorption coefficient. On the other hand, in case where the content of the inorganic hollow material is higher than 85% by weight, this results in a reduced binder amount and reduced strength.

In the case where the electromagnetic wave absorber has a small thickness (about 12 mm or smaller), the particle diameter of the inorganic hollow material is preferably not larger than ⅓ the thickness of the electromagnetic wave absorber, more preferably not larger than ¼ the thickness thereof. When the particle diameter of the inorganic hollow material exceeds ⅓ the thickness of the electromagnetic wave absorber, there is a possibility that the thickness-direction proportion of the cavities of the inorganic hollow material might be too high, resulting in reduced strength.

Due to the presence of this inorganic hollow material in the given amount, the conductive material is disposed in three-dimensional arrangement and dispersed unevenly, whereby the angle dependence of electromagnetic wave absorption is effectively reduced. The presence of the inorganic hollow material contributes also to satisfactory sound absorbing properties. In particular, it brings about excellent sound absorbing properties in the 250-500 Hz region. Thus, an electromagnetic wave absorber having an excellent function also as a sound absorber is provided.

[Conductive Material]

The electromagnetic wave absorber of the invention contains a conductive material in an amount in the range of from 0.01 to 35% by weight.

The conductive material to be used here preferably comprises at least one member selected from a fibrous conductive material, carbon black, and graphite.

The fibrous conductive material is not particularly limited as long as it has conductivity and is fibrous. Typical examples thereof include carbon fibers and metal fibers. The term “fibrous” herein means a conception which includes spiral fibers.

The carbon fibers may be either PAN fibers or pitch-based fibers.

The fiber length of the carbon fibers is preferably in the range of from 1 to 30 mm. The longer the fiber length, the smaller the fiber amount required for imparting satisfactory electromagnetic wave absorbing performance. However, carbon fibers having too large a length become entangled with one another to show poor dispersibility when dispersed in water and stirred in sheet formation by a paper making method, resulting in reduced electromagnetic wave absorbing performance. Consequently, the fiber length is preferably 30 mm or smaller. On the other hand, when the fiber length is smaller than 1 mm, there are cases where the effect of dielectric loss, which is a principle of electromagnetic wave absorption, is less apt to be obtained, leading to a decrease in electromagnetic wave absorbing performance, although such fibers have satisfactory dispersibility.

Typical examples thereof include Zailus, manufactured by Osaka Gas Co., Ltd., Tarayca, manufactured by Toray Industries, Inc., and Besfight, manufactured by Toho Rayon Co., Ltd.

The fiber length of the fibrous conductive material is preferably up to five times the thickness of the electromagnetic wave absorber, more preferably up to two times the thickness thereof. In case where the fiber length exceeds five times the thickness, a larger proportion of the fibers become entangled and this tends to result in enhanced reflecting performance. In case where the fiber length is exceedingly large, there is the possibility of resulting in enhanced reflecting properties because a larger proportion of the fibers might undergo planar orientation.

The metal fibers desirably are fibers of a metal having excellent corrosion resistance, such as, e.g., aluminum or stainless steel. The fiber length of the metal fibers is preferably in the range of from 1 to 30 mm for the same reasons as in the carbon fibers.

Typical examples thereof include Bonstar (manufactured by Nihon Steel Wool K.K.), Naslon (manufactured by Nippon Seisen Co., Ltd.), and Bekinit (manufactured by Bekinit K.K.).

The content of the fibrous conductive material is preferably from 0.01 to 2% by weight. When the content thereof is lower than 0.01% by weight, there are cases where sufficient electromagnetic wave absorbing performance cannot be secured. When the content thereof is higher than 2% by weight, there are cases where the electromagnetic wave absorber comes to have electromagnetic wave reflecting properties and the expected electromagnetic wave absorbing performance cannot be obtained.

In the case where carbon black and/or graphite is used in combination with carbon fibers and metal fibers, the amount of the carbon black and graphite to be added is such that the total amount of these ingredients is preferably from 0.01 to 35% by weight. When the amount thereof exceeds 35% by weight, there are cases where strength cannot be maintained because of the reduced binder amount. From the standpoint of noncombustibility the addition amount thereof is preferably 20% by weight or smaller.

The carbon black is not particularly limited. Examples thereof include Special BP Grade, manufactured by Cablock K. K., charcoal obtained by carbonizing wood, etc., and the like.

The graphite is not particularly limited. Examples thereof include ones produced in the Shantung Province, Heilungkiang Province, and Inner Mongolia Autonomous District in China.

In the case where carbon black and graphite are used as the only conductive materials, the content of these is from 0.01 to 35% by weight, preferably from 10 to 35% by weight.

[Binder]

The amount of the binder to be added is from 5 to 47.5% by weight. An organic binder and an inorganic binder may be used alone or in combination.

Examples of the organic binder include powders or emulsions of organic polymeric compounds and organic fibers. Examples of the inorganic binder include curable inorganic compounds or compositions, such as, e.g., hydraulic compounds or compositions which cure upon addition of water thereto and compounds or compositions which cure upon dehydration by drying, heating, or the like.

Examples of the organic polymeric compounds for use as the organic binder include starch, poly(vinyl alcohol), polyethylene, paraffin, methyl cellulose, carboxymethyl cellulose, phenolic resins, melamine resins, urea resins, epoxy resins, urethane resins, acrylic resins, modified acrylic resins, poly(vinyl acetate), ethylene/acetic acid copolymer resins, poly(vinylidene chloride) resins, modified poly(vinylidene chloride) resins, polycarbonate resins, polyolefin resins, and the like. The molecular weights of such organic polymeric compounds are usually from 180×10⁴ to 7,000×10⁴.

Examples of the organic fibers include polyolefin fibers, polyolefin-based composite fibers, poly(vinyl alcohol)-based synthetic fibers, pulps, beaten pulps, cellulose fibers, and the like.

The amount of the organic binder to be added is preferably in the range of from 5 to 25% by weight. In the case where an organic binder is used as the only binder, amounts thereof smaller than 5% by weight result in reduced strength. On the other hand, when the amount thereof exceeds 25% by weight, there are cases where noncombustibility decreases to make the electromagnetic wave absorber unusable as an interior or exterior material for buildings.

Examples of the inorganic compounds or compositions for use as the inorganic binder include hydraulic compounds or compositions which cure upon addition of water thereto, such as portland cement, magnesia cement, alumina cement, gypsum, silicic acid salts, lime, and mixtures of a silicic acid salt and lime. Examples thereof further include compounds or compositions which cure upon dehydration, such as aqueous phosphoric acid salt solutions, silica sol, alumina sol, and water glass compositions.

The content of the inorganic binder is preferably in the range of from 7 to 47.5% by weight. When the content thereof is lower than 7% by weight, there are cases where sufficient strength is not obtained. On the other hand, when the content thereof exceeds 47.5% by weight, the amount of the inorganic hollow material added is reduced and the conductive material, e.g., carbon fibers, tends to be oriented in two-dimensional arrangement. In addition, since the amount of fine powder particles is increased, there are cases where water drainage becomes poor, leading to reduced productivity in dehydrating molding.

A hardener, reaction accelerator, or coagulant can be added as an aid for strength improvement to the binder in such an amount as to displace part of the binder. Examples thereof include p-toluenesulfonic acid, phenolsulfonic acid, ammonium chloride, a mixture of fused calcium aluminate and a modified gypsum, acrylamide, aluminum sulfate, and the like. Such aids may be added in a total amount of generally up to 2.5% by weight based on the sum of the binder and the aids.

The electromagnetic wave absorber of the invention contains a filler in an amount in the range of from 0.1 to 44.99% by weight.

Examples of the filler include various inorganic powders and inorganic fibers.

Examples of the inorganic powders include natural mineral powders (preferably having a particle diameter of from 1 μm to 2 mm) such as clay, aluminum hydroxide, calcium carbonate, kaolin, talc, mica, diatomaceous earth, montmorillonite, zircon sand, magnesia, titania, alumina, silica, zirconia, cordierite, and spinel and artificial inorganic powders (preferably having a particle diameter of from 1 μm to 500 μm) such as fly ash, slug powder, and fumed silica. Such artificial inorganic powders may be ones obtained as by-products.

Such an inorganic powder may be added preferably in an amount in the range of from 0.5 to 30% by weight.

Examples of the inorganic fibers include natural mineral fibers (preferably having a diameter of from 0.1 to 20 μm and a length of from 0.5 to 100 μm) such as attapulgite, sepiolite, and wollastonite and artificial mineral fibers (preferably having a diameter of from 0.1 to 20 μm and a length of from 1 to 100 μm) such as glass fibers, glass wool, rock wool, slug wool, silica fibers, silica-titania fibers, silica-alumina fibers, zirconia fibers, alumina fibers, boron nitride fibers, silicon carbide fibers, calcium titanate fibers, and potassium titanate fibers.

It is preferred that the electromagnetic wave absorber have, on at least one side thereof, recesses and protrusions such as circular cones, circular cylinders, pyramids, prisms, stripes, pyramidal shapes, undulations, craters, or the like so as to have an improved angle dependence and to show enhanced electromagnetic wave absorbing properties when used as a wide-angle absorber.

The electromagnetic wave absorber of the invention preferably has a multilayered constitution made up of two or more superposed layers.

In this case, the constitution preferably is one in which the amount of the conductive material incorporated in the lower layer is larger than the amount of the conductive material incorporated in the upper layer. The term “upper layer” herein means the layer disposed closer to the electromagnetic wave incidence side. The term “lower layer” means the layer disposed in contact with the upper layer on the side thereof opposite to the electromagnetic wave incidence side. The amount of the conductive material added to the upper layer is from 0 to less than 35% by weight. Namely, the upper layer may be an electromagnetic wave absorber having the composition according to the invention, or may be an electromagnetic wave absorber which has the same composition as in the invention except that the content of the conductive material is from 0 to less than 0.01% by weight.

Due to this constitution, the upper layer has improved electromagnetic wave absorbing properties and the absorber can be effective in a wide region. The amount of the conductive material added to the upper layer is preferably from 0 to less than 0.05% by weight, and the amount of the conductive material added to the lower layer is larger than that in the upper layer. Preferably, the amount of the conductive material added to the lower layer is regulated so as to be larger than the conductive material amount in the upper layer by at least 0.05% by weight.

In the case where the upper layer has a conductive material content of 0% by weight, i.e., contains no conductive material, the electromagnetic wave absorber can be made to show reduced forward reflection because the inorganic hollow material itself also has a higher permittivity than air. This addition amount is used when the electromagnetic wave absorber is designed to be a high-performance electromagnetic wave absorber. When the amount of the conductive material added to the upper layer is larger than 0.05% by weight, there are cases where the forward reflection of electromagnetic waves is enhanced undesirably, resulting in difficulties in designing a high-performance electromagnetic wave absorber.

Although these layers may have an even thickness, they may be ones whose thicknesses vary regularly or randomly.

It is preferred that the electromagnetic wave absorber of the invention have electromagnetic wave reflecting properties on the side(s) thereof other than at least one side.

Electromagnetic wave reflecting properties can be imparted to a side of the electromagnetic wave absorber, for example, by applying thereto a fabric, nonwoven fabric, triaxial fabric, or quadraxial fabric each having conductivity imparted by plating or another treatment or applying thereto a metal fiber fabric, metal, metal foil, metal sheet, aluminized kraft paper (ALK), aluminized glass cloth (ALGC), metallic grid structure, or conductive coating.

Examples of methods for forming the coating having conductivity include the application or bonding of a coating material or resin containing carbon black, graphite, carbon fibers, fine metal particles, or flaky metal and the application or bonding of a conductive resin.

This layer having electromagnetic wave reflecting properties not only imparts the ability to shield from electromagnetic waves, but also can improve electromagnetic wave absorbing performance based on resonance with electromagnetic waves which have entered through the side not having electromagnetic wave reflecting properties. Thus, the electromagnetic wave absorber can combine shielding properties and absorbing properties.

The electromagnetic wave absorber preferably has, on at least one side thereof, a coating or cover having weatherability and/or water resistance.

This coating or cover comprises, for example, polyethylene, polypropylene, polycarbonate, polyester, phenolic resin, melamine resin, urea resin, acrylic resin, modified acrylic resin, poly(vinyl acetate), ethylene/acetic acid copolymer resin, poly (vinylidene chloride) resin, modified poly(vinylidene chloride) resin, epoxy resin, or urethane resin, and contains a pigment or a fibrous reinforcement according to need. It is also possible to apply an ultraviolet reflecting agent or fluorochemical in order to improve the weatherability of the resin. The thickness of this coating or cover is not particularly limited. However, in the case where high electromagnetic wave absorbing performance is required, the thickness thereof is preferably from 2 μm to 2 mm. When the thickness thereof is smaller than 2 μm, there are cases where weatherability decrease. When the thickness thereof is larger than 2 mm, there is a possibility that the surface might have the enhanced ability to reflect electromagnetic waves to form a cause of inhibition of internal absorption.

Processes for producing the electromagnetic wave absorber of the invention are not particularly limited. Examples thereof include the following methods.

A casting process which comprises introducing starting materials into a mixer, kneading the materials together with a given amount of water to obtain a slurry having the consistency of mortar, and pouring this slurry into a mold; a press forming process in which the slurry is introduced into a pressing machine and molded; and an extrusion molding process in which the slurry is molded by extrusion.

Also usable is a wet production process which comprises adding starting materials to at least a 10-fold amount of water to obtain a slurry and molding this slurry with a wet sheet-forming machine by a papermaking method.

The moldings obtained by the molding methods described above can be cured, for example, by curing with a dryer, autoclave curing, or steam curing.

### EXAMPLES

The invention will be explained below in detail by reference to Examples, but the invention should not be construed as being limited thereto.

### Example 1

| | |
|---|---|
| Perlite [Mitsui Perlite #2, manufactured by | 58.9 wt % |
| Mitsui Mining & Smelting] | |
| Carbon fibers [PAN fibers manufactured by | 0.1 wt % |
| Toho Rayon; length, 10 mm] | |
| Poly(vinyl acetate) copolymer resin emulsion | 3 wt % |
| Portland cement | 30 wt % |
| Fly ash | 8 wt % |

The portland cement, carbon fibers, and fly ash are introduced into an omni mixer and stirred for 1 minute. Thereafter, 80 parts by weight of water per 100 parts by weight of the portland cement is added thereto together with the poly(vinyl acetate) copolymer resin emulsion. This mixture is stirred for 1 minute. The perlite is further added and this mixture is stirred for 30 seconds. The slurry thus obtained is poured into a casting mold having a thickness of 25 mm coated with a release agent, and dried. After drying, the casting mold is removed. Thus, an electromagnetic wave absorber 1 was obtained.

### Example 2

| | |
|---|---|
| Perlite [Mitsui Perlite #2, manufactured by | 58.6 wt % |
| Mitsui Mining & Smelting] | |
| Carbon fibers [PAN fibers manufactured by | 0.4 wt % |
| Toho Rayon; length, 10 mm] | |
| Poly(vinyl acetate) copolymer resin emulsion | 3 wt % |
| Portland cement | 30 wt % |
| Fly ash | 8 wt % |

The carbon fibers, portland cement, and fly ash are introduced into an omni mixer and stirred for 1 minute. Thereafter, 80 parts by weight of water per 100 parts by weight of the portland cement is added thereto together with the poly(vinyl acetate) copolymer resin emulsion. This mixture is stirred for 1 minute. The perlite is further added and this mixture is stirred for 30 seconds to obtain a slurry. Into a casting mold having a thickness of 30 mm coated with a release agent is poured the slurry up to a thickness of 15 mm. A slurry having the same composition as the above one except that the perlite content is 58.98 wt % and the carbon fiber content is 0.02 wt % is prepared in the same manner, poured into the casting mold, and dried. After drying, the casting mold is removed. Thus, an electromagnetic wave absorber 2 was obtained.

### Example 3

| | |
|---|---|
| Perlite [Mitsui Perlite #2, manufactured by | 64.95 wt % |
| Mitsui Mining & Smelting] | |
| Carbon fibers [PAN fibers manufactured by | 0.25 wt % |
| Toho Rayon; length, 10 mm] | |
| Tapioca starch | 7 wt % |
| Pulp | 2 wt % |
| Rock wool | 20 wt % |
| Aluminum sulfate | 0.8 wt % |
| Attapulgite | 5 wt % |

The starting materials are added to water to obtain a slurry regulated so as to have a solid concentration of 5 wt %. This slurry is formed into a sheet using a wire paper machine and dehydrated at a press clearance of 11 mm. Thereafter, the sheet is dried to obtain a board having a thickness of 13 mm. The front side of this board is shaved. Thus, an electromagnetic wave absorber 3 having a thickness of 12 mm was obtained.

### Example 4

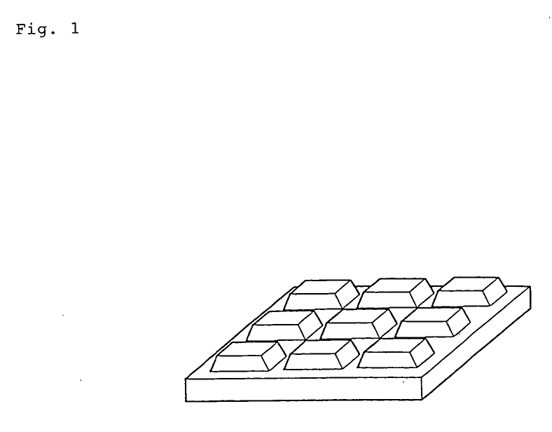

An electromagnetic wave absorber having a thickness of 30 mm was obtained in the same manner as in Example 3. This absorbed was further machined to produce an electromagnetic wave absorber 4 which had the machined side as shown in FIG. 1.

### Example 5

An aluminum foil having a thickness of 50 m was applied to the back side of the electromagnetic wave absorber 3 obtained in Example 3, i.e., to the side opposite to the shaved side (front side). Thus, an electromagnetic wave absorber 5 was obtained.

### Example 6

| | |
|---|---|
| Perlite [Mitsui Perlite #2, manufactured by | 64.9 wt % |
| Mitsui Mining & Smelting] | |
| Carbon fibers [PAN fibers manufactured by | 0.3 wt % |
| Toho Rayon; length, 3 mm] | |
| Tapioca starch | 7 wt % |
| Pulp | 2 wt % |
| Rock wool | 20 wt % |
| Aluminum sulfate | 0.8 wt % |
| Attapulgite | 5 wt % |

The starting materials are added to water to obtain a slurry regulated so as to have a solid concentration of 5 wt %. This slurry is formed into a sheet using a wire paper machine and dehydrated at a press clearance of 2 mm. Thereafter, the sheet is dried and the front side thereof is shaved. Thus, a given electromagnetic wave absorber 6 having a thickness of 4 mm was obtained.

### Comparative Example 1

| | |
|---|---|
| Perlite [Mitsui Perlite #2, manufactured by | 12 wt % |
| Mitsui Mining & Smelting] | |
| Carbon fibers [PAN fibers manufactured by | 0.1 wt % |
| Toho Rayon; length, 10 mm] | |
| Poly(vinyl acetate) copolymer resin emulsion | 3 wt % |
| Portland cement | 53 wt % |
| Fly ash | 31.9 wt % |

The portland cement, carbon fibers, and fly ash are introduced into an omni mixer and stirred for 1 minute. Thereafter, 80 parts by weight of water per 100 parts by weight of the portland cement is added thereto together with the poly(vinyl acetate) copolymer resin emulsion. This mixture is stirred for 1 minute. The perlite is further added and this mixture is stirred for 30 seconds. The slurry thus obtained is poured into a casting mold having a thickness of 25 mm coated with a release agent, and dried. After drying, the casting mold is removed. Thus, an electromagnetic wave absorber a was obtained.

### Comparative Example 2

| | |
|---|---|
| Perlite [Mitsui Perlite #2, manufactured by | 20 wt % |
| Mitsui Mining & Smelting] | |
| Carbon fibers [PAN fibers manufactured by | 0.25 wt % |
| Toho Rayon; length, 10 mm] | |
| Tapioca starch | 7 wt % |
| Pulp | 2 wt % |
| Rock wool | 64.95 wt % |
| Aluminum sulfate | 0.8 wt % |
| Attapulgite | 5 wt % |

The starting materials are added to water to obtain a slurry regulated so as to have a solid concentration of 5 wt %. This slurry is formed into a sheet using a wire paper machine and dehydrated at a press clearance of 11 mm. Thereafter, the sheet is dried to obtain a board having a thickness of 13 mm. The front side of this board is shaved. Thus, a given electromagnetic wave absorber b having a thickness of 12 mm was obtained.

### Comparative Example 3

| | |
|---|---|
| Perlite [Mitsui Perlite #2, manufactured by | 40.0 wt % |
| Mitsui Mining & Smelting] | |
| Carbon fibers [PAN fibers manufactured by | 0.3 wt % |
| Toho Rayon; length, 3 mm] | |
| Poval | 15 wt % |
| Pulp | 1 wt % |
| Glass fibers | 25 wt % |
| Aluminum sulfate | 0.8 wt % |
| Aluminum hydroxide | 17.9 wt % |

The starting materials are added to water to obtain a slurry regulated so as to have a solid concentration of 5 wt %. This slurry is formed into a sheet using a wire paper machine and dehydrated at a press clearance of 9 mm. Thereafter, the sheet is dried and the front side thereof is shaved. Thus, a given electromagnetic wave absorber c having a thickness of 12 mm was obtained.

The electromagnetic wave absorbers 1 to 6 and a to c obtained above were evaluated for flexural strength, fireproof performance, electromagnetic wave absorbing performance, and workability in the following manners. The results are shown in Table 1.

[Flexural Strength]

Measured in accordance with JIS A 1408.

[Fireproof Performance]

Ones which passed the test as provided for in Notification No. 1400 of the Ministry of Construction, Japan, 2000 (noncombustible materials) were rated as noncombustible.

Ones which passed the test as provided for in Notification No. 1401 of the Ministry of Construction, Japan, 2000 (quasi-noncombustible materials) were rated as quasi-noncombustible.

[Electromagnetic Wave Absorbing Performance]

A test sample was evaluated for electromagnetic wave absorption attributable to the internal loss possessed by the test sample itself while preventing resonance with reflected electromagnetic waves, so as to examine suitability for use in the fields of building and engineering works. For this examination, the reflection coefficient of a metallic body (stainless-steel plate of 1 m ×1 m ×5 mm) was determined by the free-space time domain method. After the metallic body was removed, a test sample having the same size as the metallic body was installed in the same position as the metallic body and examined for reflection coefficient in the same manner. This measurement was made in an electromagnetic dark room using an electromagnetic wave of 2.54 GHz.

Electromagnetic wave absorbing performance (dB)
=[reflection level of the metallic body (dB)]
−[reflection level of the absorber (dB)]

In the measurement, the incidence angle was changed as shown in Table 1. The term “incidence angle” means the angle with the perpendicular to the test side of the absorber. Namely, the term “incidence angle of 0 degree” means incidence at the angle which is perpendicular to the absorber surface. [Workability] Ones which could be easily processed with a cutter and saw are indicated by A, while ones which could not be easily processed therewith are indicated by B.

TABLE 1

| | | | | | | | | Comp. | Comp. | Comp. |
|---|---|---|---|---|---|---|---|---|---|---|
| | | Ex. 1 | Ex. 2 | Ex. 3 | Ex. 4 | Ex. 5 | Ex. 6 | Ex. a | Ex. b | Ex. c |
| Flexural strength (kgf/cm²) | | 24.5 | 21.8 | 18.7 | 16.5 | 28.2 | 20.5 | 44.2 | 19.1 | 20.5 |
| Fireproof performance | | non- | non- | non- | non- | non- | quasi-non- | non- | non- | quasi-non- |
| | | combus- | combus- | combus- | combus- | combus- | combus- | combus- | combus- | combus- |
| | | tible | tible | tible | tible | tible | tible | tible | tible | tible |
| Electro- | Incidence angle | 8.1 | 16.4 | 6.9 | 15.9 | 13 | 8.2 | 7.6 | 7.2 | 6.5 |
| magnetic | 0 degree | | | | | | | | | |
| wave | Incidence angle | 7.7 | 15.8 | 6.5 | 16.5 | 11.7 | 7.6 | 5.3 | 5.0 | 5.2 |
| absorbing | 20 degrees | | | | | | | | | |
| performance | Incidence angle | 6.5 | 14.6 | 5.8 | 13.0 | 9.6 | 7.6 | 4.1 | 3.6 | 3.3 |
| (Db) | 40 degrees | | | | | | | | | |
| | Incidence angle | 6.2 | 10.8 | 5.7 | 10.6 | 9.5 | 7.0 | 2.8 | 1.9 | 2.5 |
| | 60 degrees | | | | | | | | | |
| Workability | A | A | A | A | A | A | B | A | A | |

As apparent from the results given in Table 1, the electromagnetic wave absorbers of the invention were excellent in the various performances.

While the invention has been described in detail and with reference to specific embodiments thereof, it will be apparent to one skilled in the art that various changes and modifications can be made therein without departing from the spirit and scope thereof.

### INDUSTRIAL APPLICABILITY

The electromagnetic wave absorber of the invention absorbs electromagnetic waves striking thereon at angles in a wide range. The absorber can hence be extensively utilized in various fields including the fields of building and engineering works in order to improve electromagnetic wave environments.

1. An electromagnetic wave absorber comprising from 50 to 85% by weight of an inorganic hollow material, from 0.01 to 35% by weight of a conductive material, from 5 to 47.5% by weight of a binder, and from 0.1 to 47.5% by weight of a filler.

2. The electromagnetic wave absorber according to claim 1, wherein the inorganic hollow material comprises at least one member selected from perlite, shirasu balloons, silica balloons, glass beads, and alumina-silica balloons.

3. The electromagnetic wave absorber according to claim 1, wherein the conductive material comprises at least one member selected from a fibrous conductive material, carbon black, and graphite.

4. The electromagnetic wave absorber according to claim 3, wherein the fibrous conductive material comprises at least one member selected from carbon fibers and metal fibers.

5. The electromagnetic wave absorber according to claim 4, wherein a content of the fibrous conductive material is from 0.01 to 2% by weight.

6. The electromagnetic wave absorber according to claim 3, wherein the conductive material is a fibrous conductive material and the fibrous conductive material has a length not larger than five times a thickness of the electromagnetic wave absorber.

7. The electromagnetic wave absorber according to claim 1, wherein the binder comprises at least one member selected from a powder or emulsion of an organic polymeric compound and organic fibers.

8. The electromagnetic wave absorber according to claim 7, wherein a content of the binder is from 5 to 25% by weight.

9. The electromagnetic wave absorber according to claim 1, wherein the binder comprises at least one member selected from curable inorganic compounds or compositions.

10. The electromagnetic wave absorber according to claim 1, wherein the filler comprises at least one member selected from inorganic powders and inorganic fibers.

11. The electromagnetic wave absorber according to claim 1, which has a shape with recesses and protrusions.

12. The electromagnetic wave absorber according to claim 1, which has a side having electromagnetic wave reflecting properties and a side not having electromagnetic wave reflecting properties.

13. A multilayered electromagnetic wave absorber, which comprises a multilayer structure comprising two or more layers of the electromagnetic wave absorber according to claim 1, wherein an amount of the conductive material added to an upper layer is from 0 to 35% by weight and a content of the conductive material in a lower layer is higher than in the upper layer.
